(19) United States
(12) Patent Application Publication
(10) Pub. No.: US 2024/0289113 A1
(43) Pub. Date: Aug. 29, 2024

(54) Techniques to Proactively Monitor and Initiate Communication System Updates Using Interactive Chat Machine Learning Models

(71) Applicant: STATE FARM MUTUAL AUTOMOBILE INSURANCE COMPANY, Bloomington, IL (US)

(72) Inventor: Trystan Bates-Maricle, Bloomington, IL (US)

(21) Appl. No.: 18/242,676

(22) Filed: Sep. 6, 2023

Related U.S. Application Data
(60) Provisional application No. 63/450,838, filed on Mar. 8, 2023.
(60) Provisional application No. 63/486,596, filed on Feb. 23, 2023.

(51) Int. Cl. G06F 8/65; G06N 20/00; H04L 41/16; H04L 51/02

(52) U.S. Cl. CPC G06F 8/65; G06N 20/00; H04L 41/16; H04L 51/02

(57) ABSTRACT

Techniques for proactively managing updates in a communication system are disclosed herein. An exemplary computer-implemented method may include retrieving a set of data corresponding to the communication system from one or more sources external to the communication system. The exemplary method may further include determining, by executing a machine learning (ML) chatbot, that the set of data indicates a potential update to at least one component of the communication system. The exemplary method may further include generating, by executing the ML chatbot, an update indication corresponding to the set of data. The exemplary method may further include displaying the update indication on a user interface for viewing by a user.

### CROSS-REFERENCE TO RELATED APPLICATIONS

This application claims priority to U.S. Provisional Patent Application No. 63/450,838, entitled “Techniques to Proactively Monitor and Initiate Communication System Updates Using Interactive Chat Machine Learning Models,” filed on Mar. 8, 2023, U.S. Provisional Patent Application No. 63/486,596, entitled “Techniques to Proactively Monitor and Initiate Communication System Updates Using Interactive Chat Machine Learning Models,” filed on Feb. 23, 2023, and to U.S. Provisional Patent Application No. 63/485,741, entitled “Techniques for Improving Communication Processing Through Interactive Chat Machine Learning Models,” filed on Feb. 17, 2023, the disclosures of each of which are hereby incorporated herein by reference.

### TECHNICAL FIELD

The present disclosure generally relates to systems and methods for monitoring communication system activity, and more particularly, to proactively monitoring and initiating communication system updates using interactive chat machine learning models, such as machine learning-based chatbots/voice bots.

### BACKGROUND

Generally speaking, communication systems may involve a variety of components operating together to perform various communication operations. These systems, and the corresponding operations, may be incredibly complex, and may require frequent updates to preserve steady, reliable performance. Paramount to providing such frequent updates may be the accurate/efficient monitoring and determination of relevant updates for communication system subsystems/components.

However, conventional techniques generally may suffer from a lack of such accurate and efficient monitoring/determination capabilities. In particular, conventional techniques typically may require information technology (IT) professionals, live agents, or other operators to intuitively recognize or otherwise discover any/all updates corresponding to various components of a communication system. When a potential update is identified, these operators may also typically be required to manually initiate the update process by generating update templates and overseeing the update functions. Thus, at both stages (i.e., monitoring, implementation), the communication system may not assist operators with updating subsystems/components. As a result, these conventional techniques may frequently overlook potential updates that may drastically improve the functioning and/or may enable the continued operation of such subsystems/components. Consequently, conventional techniques may waste significant computing and operator resources in the pursuit of manual monitoring, implementing, and/or otherwise non-optimal updating strategies, and thereby prolong communication system subsystem/component downtime as a result of delayed and/or unapplied updates.

Therefore, in general, proper update monitoring and implementation/initiation for a communication system may be an area of great interest, and conventional techniques may be insufficient for providing such proper monitoring/implementation. Accordingly, a need exists for systems and methods for proactively monitoring and initiating communication system updates using interactive chat machine learning models to provide communication system operators with accurate, efficient update monitoring/implementation information for mitigating negative impacts from a lack of applying such updates. Conventional techniques may include additional inefficiencies, ineffectiveness, encumbrances, and/or other drawbacks as well.

### SUMMARY

Broadly speaking, the techniques of the present disclosure may include frequently inputting data from social media platforms and/or other data sources into a trained AI/ML chatbot (or voice bot) to generate responses indicating upcoming system updates. In certain embodiments, the system may be and/or include a communication system configured to receive communications from external users, route the external users to an appropriate subsystem (e.g., connect the user to a live agent, transmit communications to an automated response subsystem) within the communication system for processing, and process those communications. Of course, it should be appreciated that the system may be any suitable system in which updates may be received and/or processed.

In circumstances where the AI/ML chatbot indicates an upcoming system update, the system may also utilize the AI/ML chatbot to proactively generate inputs to update/change templates required as part of the upcoming system updates. In particular, the system may push data from any suitable social media platform and/or other platform into the AI/ML chatbot when the system identifies language in the data corresponding to some aspect of the system. For example, the system may identify a reference in a social media post to a cloud-based service (e.g., AWS) utilized by the system. The system may retrieve and/or otherwise gather data from the social media post, transmit that data to the AI/ML chatbot, and the AI/ML chatbot may generate responses indicating whether there is an upcoming update to the cloud-based service and/or a draft template corresponding to the update. Users responsible for monitoring and/or otherwise tracking the performance of the customer service platform components may review these responses to determine the accuracy/applicability of such responses.

One exemplary embodiment of the present disclosure may be a computer-implemented method for proactively managing updates in a communication system. The computer-implemented method may be implemented via one or more local or remote processors, servers, sensors, transceivers, mobile devices, wearables, smart watches, smart contact lenses, voice bots, chat bots, ChatGPT bots, smart glasses, augmented reality glasses, virtual reality headsets, mixed or extended reality headsets or glasses, and other electronic or electrical components, which may be in wired or wireless communication with one another. For example, in one instance, the method may include: (1) retrieving, by one or more processors, a set of data corresponding to the communication system from one or more sources external to the communication system; (2) determining, by the one or more processors executing a machine learning (ML) chatbot, that the set of data indicates a potential update to at least one component of the communication system, wherein the ML chatbot is trained with a plurality of training data corresponding to the communication system as inputs to generate a plurality of training update indications as outputs; (3) generating, by the one or more processors executing the ML chatbot, an update indication corresponding to the set of data; and/or (4) displaying, by the one or more processors, the update indication on a user interface for viewing by a user (or presenting, by the one or more processors and/or the ML chatbot, the update indication via voice or audible interaction generated by the ML chatbot, or presenting an audible indication corresponding to the update indication to a user via the ML chatbot or a speaker associated with the ML chatbot). The method may include additional, less, or alternate functionality and actions, including those discussed elsewhere herein.

For instance, in a variation of this embodiment, generating the update indication may further include: generating, by the one or more processors executing the ML chatbot, the update indication corresponding to the set of data and an update template associated with the update indication, wherein the update template includes data from the set of data required to process the update for the communication system. Further in this variation, the ML chatbot may be further trained using a plurality of training user inputs corresponding to a plurality of training update templates, and the method may further include: receiving, at the one or more processors, a user input corresponding to the update indication; and/or generating, by the one or more processors executing the ML chatbot, the update template based upon the user input and in a style representative of the user input.

In another variation of this embodiment, the update indication may include (i) a predicted update associated with at least one component of the communication system, (ii) a predicted impact of the predicted update, and/or (iii) a predicted time of the predicted update. Further in this variation, the method may further comprise: receiving, at the one or more processors, a user input including (i) a first indication corresponding to the predicted update associated with the at least one component of the communication system, (ii) a second indication corresponding to an impact of the predicted update to the communication system, and/or (iii) third indication corresponding to a time of the predicted update; and re-training, by the one or more processors, the ML chatbot based upon the user input.

In yet another variation of this embodiment, determining that the set of data indicates a potential update may further include: (i) generating, by the one or more processors, one or more embeddings associated with the set of data; (ii) comparing, by the one or more processors, the one or more embeddings to a library of embeddings; and/or (iii) determining, by the one or more processors, that the set of data indicates a potential update based upon the comparing. Further in this variation, generating the update indication may further include: retrieving, by the one or more processors, one or more prior update indications from an update indication database based upon the one or more embeddings; and generating, by the one or more processors executing the ML chatbot, the update indication based upon the set of data and the one or more prior update indications.

In still another variation of this embodiment, generating the update indication may further include: (i) inputting, by the one or more processors, a plurality of documentation corresponding to the communication system into the ML chatbot; and/or (ii) generating, by the one or more processors executing the ML chatbot, the update indication based upon the set of data corresponding to the communication system and the plurality of documentation.

In yet another variation of this embodiment, the potential update to the at least one component of the communication system may correspond to at least one of: (i) a software update, and/or (ii) a hardware update.

In still another variation of this embodiment, the one or more sources external to the communication system may include one or more of: (i) a social media platform, (ii) a news platform, (iii) a blog, (iv) a manufacturer website, and/or (v) a service provider website; and the set of data corresponding to the communication system may include one or more of: (i) a social media post, (ii) an article posted on a news platform, (iii) a blog excerpt, and/or (iv) a portion of the manufacturer website or the service provider website.

Another exemplary embodiment of the present disclosure may be a system for proactively managing updates in a communication system. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the system may include: a user interface; one or more processors; and a non-transitory computer-readable memory coupled to the one or more processors and the user interface, the memory storing instructions thereon that, when executed by the one or more processors, may cause the one or more processors to: (1) retrieve a set of data corresponding to the communication system from one or more sources external to the communication system; (2) determine, by executing a machine learning (ML) chatbot, that the set of data indicates a potential update to at least one component of the communication system, wherein the ML chatbot is trained with a plurality of training data corresponding to the communication system as inputs to generate a plurality of training update indications as outputs; (3) generate, by executing the ML chatbot, an update indication corresponding to the set of data; and/or (4) display the update indication on the user interface for viewing by a user (and/or present, by the one or more processors and/or the ML chatbot, the update indication via voice or audible interaction generated by the ML chatbot, or presenting an audible indication corresponding to the update indication to a user via the ML chatbot or a speaker associated with the ML chatbot). The system may be configured to include additional, less, or alternate functionality, including that discussed elsewhere herein.

For instance, in a variation of this embodiment, the instructions, when executed, further cause the one or more processors to generate the update indication by: generating, by executing the ML chatbot, the update indication corresponding to the set of data and an update template associated with the update indication, and wherein the update template includes data from the set of data required to process the update for the communication system. Further in this variation, the ML chatbot may be further trained using a plurality of training user inputs corresponding to a plurality of training update templates, and the instructions, when executed, may further cause the one or more processors to: (i) receive a user input corresponding to the update indication; and/or (ii) generate, by executing the ML chatbot, the update template based upon the user input and in a style representative of the user input.

In another variation of this embodiment, the update indication may include (i) a predicted update associated with at least one component of the communication system, (ii) a predicted impact of the predicted update, and/or (iii) a predicted time of the predicted update. Further in this variation, the instructions, when executed, may further cause the one or more processors to: receive a user input including (i) a first indication corresponding to the predicted update associated with the at least one component of the communication system, (ii) a second indication corresponding to an impact of the predicted update to the communication system, and/or (iii) third indication corresponding to a time of the predicted update; and re-train the ML chatbot based upon the user input.

In yet another variation of this embodiment, the instructions, when executed, may further cause the one or more processors to determine that the set of data indicates a potential update by: generating one or more embeddings associated with the set of data; comparing the one or more embeddings to a library of embeddings; and determining that the set of data indicates a potential update based upon the comparing. Further in this variation, the instructions, when executed, may further cause the one or more processors to generate the update indication by: (i) retrieving one or more prior update indications from an update indication database based upon the one or more embeddings; and/or (ii) generating, by executing the ML chatbot, the update indication based upon the set of data and the one or more prior update indications.

In still another variation of this embodiment, the instructions, when executed, may further cause the one or more processors to generate the update indication by: (i) inputting a plurality of documentation corresponding to the communication system into the ML chatbot; and/or (ii) generating, by executing the ML chatbot, the update indication based upon the set of data corresponding to the communication system and the plurality of documentation.

In yet another variation of this embodiment, the one or more sources external to the communication system may include one or more of: (i) a social media platform, (ii) a news platform, (iii) a blog, (iv) a manufacturer website, and/or (v) a service provider website; and the set of data corresponding to the communication system may include one or more of: (i) a social media post, (ii) an article posted on a news platform, (iii) a blog excerpt, and/or (iv) a portion of the manufacturer website or the service provider website.

Yet another exemplary embodiment of the present disclosure may be a tangible machine-readable medium comprising instructions for proactively managing updates in a communication system that, when executed, may cause a machine to at least: retrieve a set of data corresponding to the communication system from one or more sources external to the communication system; determine, by executing a machine learning (ML) chatbot, that the set of data indicates a potential update to at least one component of the communication system, wherein the ML chatbot is trained with a plurality of training data corresponding to the communication system as inputs to generate a plurality of training update indications as outputs; generate, by executing the ML chatbot, an update indication corresponding to the set of data; and/or display the update indication on the user interface for viewing by a user (and/or presenting, by the machine, one or more processors, and/or the ML chatbot, the update indication via voice or audible interaction generated by the ML chatbot, or presenting an audible indication corresponding to the update indication to a user via the ML chatbot or a speaker associated with the machine or the ML chatbot). The instructions may direct additional, less, or alternate functionality, including that discussed elsewhere herein.

Still another exemplary embodiment of the present disclosure may be a system for proactively managing updates in a communication system. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the system may include: a user interface; one or more processors; and a non-transitory computer-readable memory coupled to the one or more processors and the user interface, the memory storing instructions thereon that, when executed by the one or more processors, may cause the one or more processors to: (1) retrieve a set of data corresponding to the communication system from one or more sources external to the communication system; (2) determine, by executing an artificial intelligence (AI) chatbot, that the set of data indicates a potential update to at least one component of the communication system, wherein the AI chatbot is trained with a plurality of training data corresponding to the communication system as inputs to generate a plurality of training update indications as outputs; (3) generate, by executing the AI chatbot, an update indication corresponding to the set of data; and/or (4) display the update indication on the user interface for viewing by a user (and/or presenting, by the one or more processors and/or the AI or a ML chatbot, the update indication via voice or audible interaction generated by the AI or ML chatbot, or presenting an audible indication corresponding to the update indication to a user via the AI or ML chatbot or a speaker associated with the AI or ML chatbot). The system may be configured to include additional, less, or alternate functionality, including that discussed elsewhere herein.

Yet another exemplary embodiment of the present disclosure may be a tangible machine-readable medium comprising instructions for proactively managing updates in a communication system that, when executed, may cause a machine to at least: retrieve a set of data corresponding to the communication system from one or more sources external to the communication system; determine, by executing an artificial intelligence (AI) chatbot, that the set of data indicates a potential update to at least one component of the communication system, wherein the AI chatbot is trained with a plurality of training data corresponding to the communication system as inputs to generate a plurality of training update indications as outputs; generate, by executing the AI chatbot, an update indication corresponding to the set of data; and/or display the update indication on the user interface for viewing by a user (and/or presenting, by the machine, one or more processors. and/or the AI or a ML chatbot, the update indication via voice or audible interaction generated by the AI or ML chatbot, or presenting an audible indication corresponding to the update indication to a user via the AI or ML chatbot or a speaker associated with the AI or ML chatbot or the machine). The instructions may direct additional, less, or alternate functionality, including that discussed elsewhere herein.

Still another exemplary embodiment of the present disclosure may be a computer-implemented method for proactively managing updates in a communication system. The computer-implemented method may be implemented via one or more local or remote processors, servers, sensors, transceivers, mobile devices, wearables, smart watches, smart contact lenses, voice bots, chat bots, ChatGPT bots, smart glasses, augmented reality glasses, virtual reality headsets, mixed or extended reality headsets or glasses, and other electronic or electrical components, which may be in wired or wireless communication with one another. For example, in one instance, the method may include: (1) retrieving, by one or more processors, a set of data corresponding to the communication system from one or more sources external to the communication system; (2) determining, by the one or more processors executing an artificial intelligence (AI) chatbot, that the set of data indicates a potential update to at least one component of the communication system, wherein the AI chatbot is trained with a plurality of training data corresponding to the communication system as inputs to generate a plurality of training update indications as outputs; (3) generating, by the one or more processors executing the AI chatbot, an update indication corresponding to the set of data; and/or (4) displaying, by the one or more processors, the update indication on a user interface for viewing by a user (and/or presenting, by the one or more processors and/or the AI or a ML chatbot, the update indication via voice or audible interaction generated by the AL or ML chatbot, or presenting an audible indication corresponding to the update indication to a user via the AI or ML chatbot or a speaker associated with the AI or ML chatbot, or the one or more processors). The method may include additional, less, or alternate functionality and actions, including those discussed elsewhere herein.

Yet another exemplary embodiment of the present disclosure may be a system for proactively managing updates in a communication system. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the system may include: a user interface; one or more processors; and a non-transitory computer-readable memory coupled to the one or more processors and the user interface, the memory storing instructions thereon that, when executed by the one or more processors, may cause the one or more processors to: (1) retrieve a set of data corresponding to the communication system from one or more sources external to the communication system; (2) determine, by executing a machine learning (ML) chatbot, that the set of data indicates a potential update to at least one component (such as a server, trunking service, cloud-based hosting platform, mobile device, computing device, wearable, virtual reality headset, augmented reality glasses, voice or chat bot, or AI or ML chat bot) of the communication system, wherein the ML chatbot is trained with a plurality of training data corresponding to the communication system as inputs to generate a plurality of training update indications as outputs; (3) generate, by executing the ML chatbot, an update indication corresponding to the set of data; and/or (4) display the update indication via the user interface (such as present the update indication via a voice bot or chatbot and/or speaker, or a display screen). The system may be configured to include additional, less, or alternate functionality, including that discussed elsewhere herein.

Still another exemplary embodiment of the present disclosure may be a system for proactively managing updates in a communication system. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the system may include: a user interface; one or more processors; and a non-transitory computer-readable memory coupled to the one or more processors and the user interface, the memory storing instructions thereon that, when executed by the one or more processors, may cause the one or more processors to: (1) retrieve a set of data corresponding to the communication system from one or more sources external to the communication system; (2) determine, by executing an artificial intelligence (AI) chatbot, that the set of data indicates a potential update to at least one component (such as a server, trunking service, cloud-based hosting platform, mobile device, computing device, wearable, virtual reality headset, augmented reality glasses, voice or chat bot, or AI or ML chat bot) of the communication system, wherein the AI chatbot is trained with a plurality of training data corresponding to the communication system as inputs to generate a plurality of training update indications as outputs; (3) generate, by executing the AI chatbot, an update indication corresponding to the set of data; and/or (4) display the update indication via the user interface (such as present the update indication via a voice bot or chatbot and/or speaker, or display on a display screen). The system may be configured to include additional, less, or alternate functionality, including that discussed elsewhere herein.

In accordance with the above, and with the disclosure herein, the present disclosure includes improvements in computer functionality or in improvements to other technologies at least because the disclosure describes that, e.g., a hosting server (e.g., central server), or otherwise computing device (e.g., a user computing device), is improved where the intelligence or predictive ability of the hosting server or computing device is enhanced by a trained machine learning chatbot/voice bot. This model, executing on the hosting server or user computing device, is able to accurately and efficiently determine potential updates to communication system subsystems/components and generate update indications corresponding to those potential updates.

That is, the present disclosure describes improvements in the functioning of the computer itself or “any other technology or technical field” because a hosting server or user computing device, is enhanced with a trained machine learning chatbot/voice bot to accurately detect, evaluate, predict, and generate communication system-specific conditions and recommendations configured to improve the respective operator's maintenance and updating efforts related to a communication system and associated devices. This improves over the prior art at least because existing systems lack such evaluative and/or predictive functionality, and are generally unable to accurately analyze such external data on a real-time basis to output predictive and/or otherwise recommended results designed to improve an operator's overall maintenance and updating efforts related to a communication system and associated devices.

As mentioned, the model(s) may be trained using machine learning and may utilize machine learning during operation. Therefore, in these instances, the techniques of the present disclosure may further include improvements in computer functionality or in improvements to other technologies at least because the disclosure describes such models being trained with a plurality of training data (e.g., 10,000s of training data corresponding to the communication system, update indications, etc.) to output the communication system-specific conditions and recommendations configured to improve the respective operator's maintenance and updating efforts related to a communication system and associated devices.

Moreover, the present disclosure includes effecting a transformation or reduction of a particular article to a different state or thing, e.g., transforming or reducing the maintenance and updating of a communication system (and associated subsystems/components/devices) from a non-optimal or error state to an optimal state.

Still further, the present disclosure includes specific features other than what is well-understood, routine, conventional activity in the field, or adding unconventional steps that demonstrate, in various embodiments, particular useful applications, e.g., determining, by the one or more processors executing a machine learning (ML) chatbot, that the set of data indicates a potential update to at least one component of the communication system, wherein the ML chatbot is trained with a plurality of training data corresponding to the communication system as inputs to generate a plurality of training update indications as outputs; generating, by the one or more processors executing the ML chatbot, an update indication corresponding to the set of data; and/or displaying, by the one or more processors, the update indication on a user interface for viewing by a user (or presenting, by the one or more processors and/or the ML chatbot, the update indication via voice or audible interaction generated by the ML chatbot, or presenting an audible indication corresponding to the update indication to a user via the ML chatbot or a speaker associated with the ML chatbot).

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 depicts an exemplary computing system in which various embodiments of the present disclosure may be implemented.

FIG. 2A depicts a first exemplary workflow for data input/output of a computing device, for the example of FIG. 1, in accordance with various embodiments described herein.

FIG. 2B depicts a second exemplary workflow for data input/output of a computing device, for the example of FIG. 1, in accordance with various embodiments described herein.

FIG. 3 depicts an exemplary graphical user interface (GUI) that may be displayed on a computing device, in accordance with various embodiments described herein.

FIG. 4 depicts a flow diagram representing an exemplary computer-implemented method, in accordance with various embodiments described herein.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

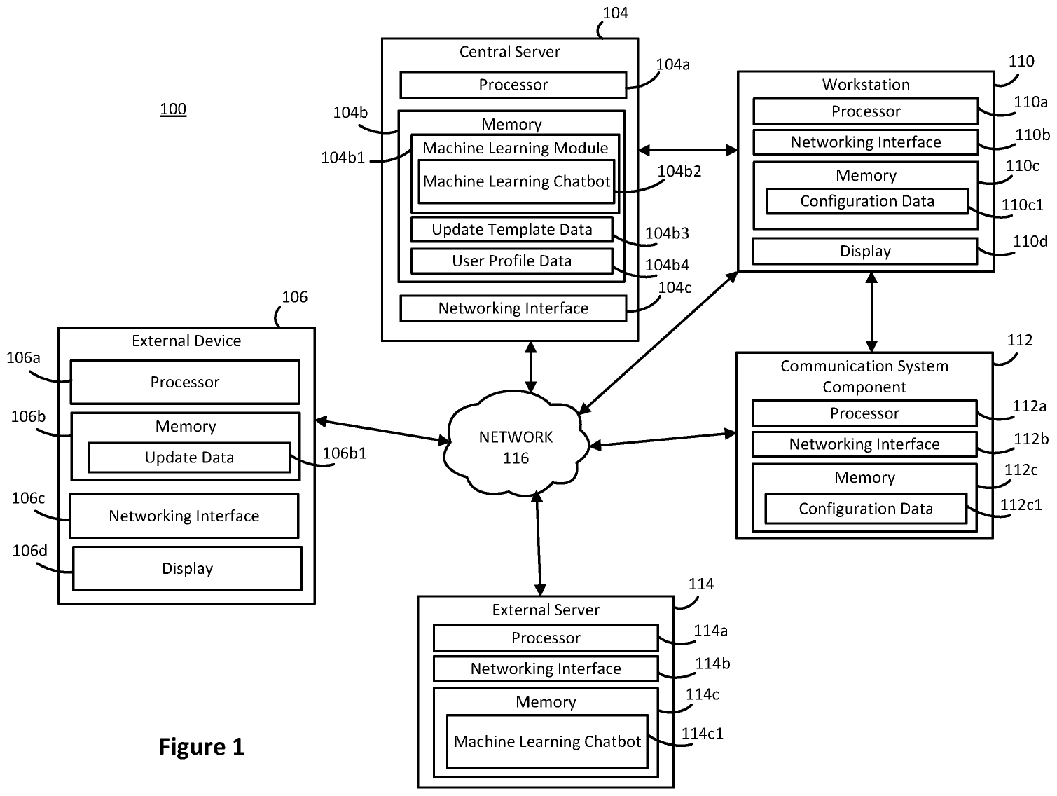

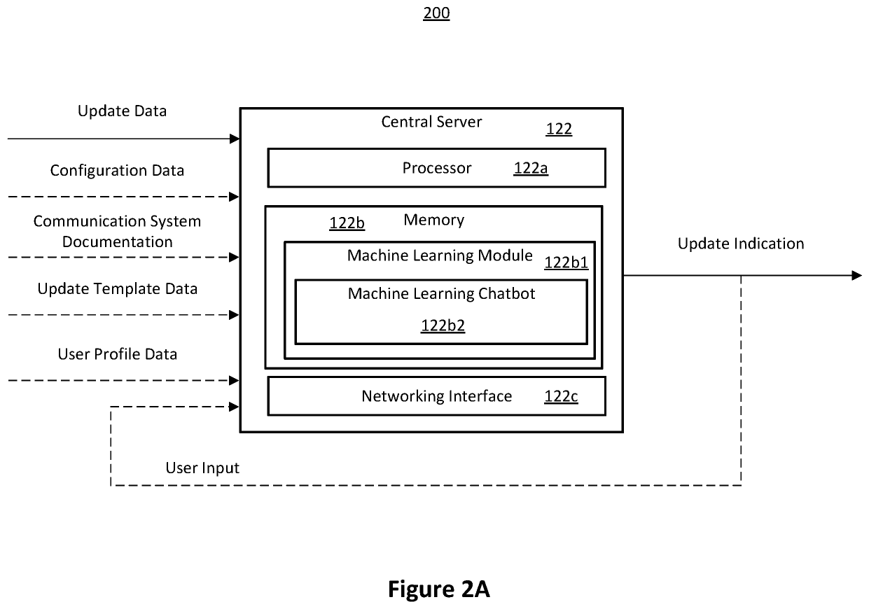

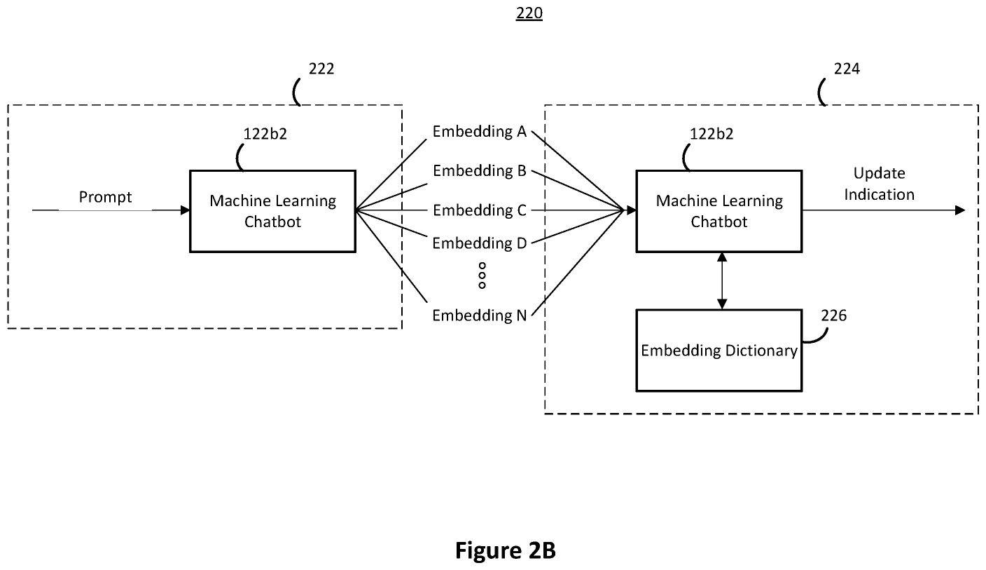

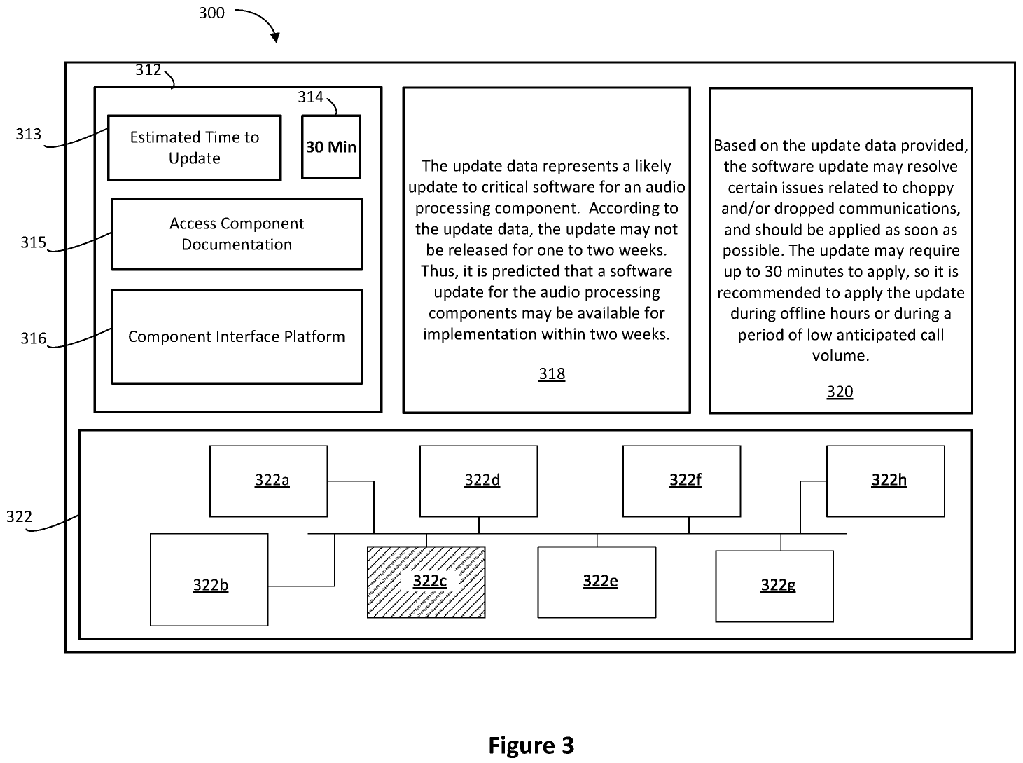

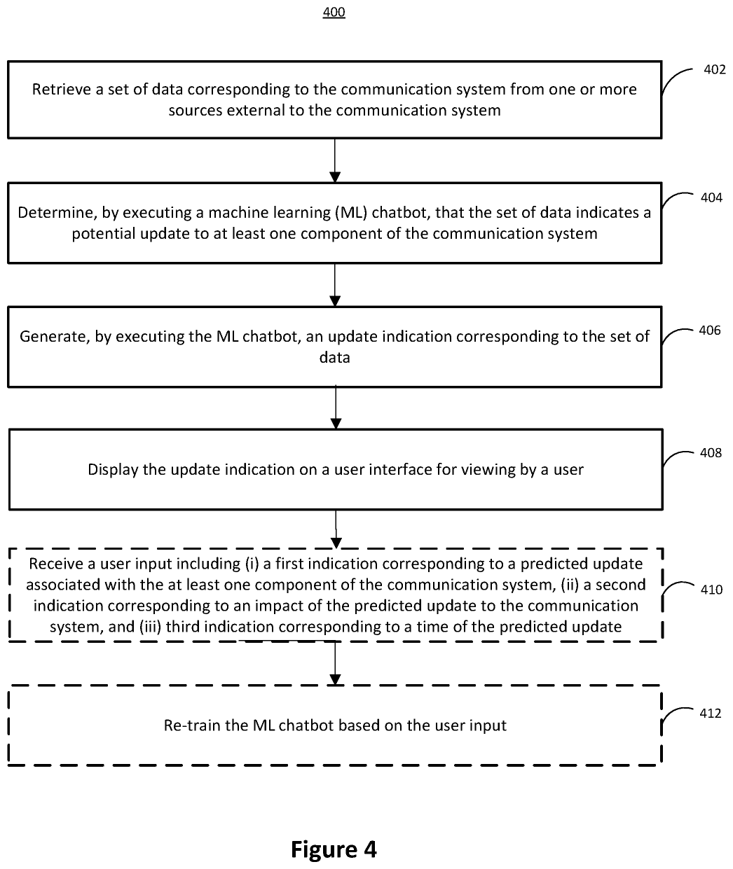

As previously mentioned, the systems and methods of the present disclosure generally relate to, inter alia, proactively monitoring and initiating communication system updates using interactive chat machine learning models (referenced herein as a “machine learning chatbot”, “artificial intelligence chatbot”, “machine learning voice bot”, and/or “artificial intelligence voice bot”). To provide a better understanding of the systems and methods described herein, FIG. 1 depicts an exemplary computing environment in which techniques of the present disclosure may be implemented, and FIGS. 2A and 2B illustrate how some of these system components may process sets of data corresponding to the communication system (also referenced herein as “update data”) and/or other data to generate update indications. FIG. 3 depicts an exemplary GUI that may feature and/or otherwise display information included as part of and/or extracted from the generated update indications. FIG. 4 illustrates an exemplary computer-implemented method workflow for proactively monitoring and initiating communication system updates and how such monitoring/initiating updates may, in certain embodiments, be used to re-train and/or otherwise continuously improve the functioning of the machine learning chatbot during subsequent iterations.

In some embodiments, generative artificial intelligence (AI) models (also referred to as generative machine learning (ML) models) including voice bots or chatbots may be configured to utilize artificial intelligence and/or machine learning techniques. Data input into the voice bots, chatbots, or other bots may include historical insurance claim data, historical home data, historical water damage data, sensor information, damage mitigation and prevention techniques, and other data. The data input into the bot or bots may include text, documents, and images, such as text, documents and images related to homes, claims, and water damage, damage mitigation and prevention, and sensors. In certain embodiments, a voice or chatbot may be a ChatGPT chatbot. The voice or chatbot may employ supervised or unsupervised machine learning techniques, which may be followed by, and/or used in conjunction with, reinforced or reinforcement learning techniques. In one aspect, the voice or chatbot may employ the techniques utilized for ChatGPT. The voice bot, chatbot, ChatGPT-based bot, ChatGPT bot, and/or other such generative model may generate audible or verbal output, text or textual output, visual or graphical output, output for use with speakers and/or display screens, and/or other types of output for user and/or other computer or bot consumption.

### Exemplary Computing System

FIG. 1 depicts an exemplary computing system 100 in which various embodiments of the present disclosure may be implemented. Depending on the embodiment, the exemplary computing system 100 may generate an error diagnosis, an update indication, a response to a user query articulated in accordance with a stylistic/contextual scheme, responses to live prompts across a communication channel of the computing system 100, and/or any other values, responses, or combinations thereof. Of course, it should be appreciated that, while the various components of the exemplary computing system 100 (e.g., central server 104, external device 106, communication system component 112, etc.) are illustrated in FIG. 1 as single components, the exemplary computing system 100 may include multiple (e.g., dozens, hundreds, thousands) of each of the components that are simultaneously connected to the network 116 at any given time.

Generally speaking, the exemplary computing system 100 may include a central server 104, a workstation 110, an external device 106, a communication system component 112, and an external server 114. As referenced herein, a “communication system” may be or include at least the central server 104, the workstation 110, the communication system component 112, and/or any other suitable devices or combinations thereof. For example, the communication system may be or include a contact center configured to field incoming calls, web-based chats, video communications, and/or any other suitable communications or combinations thereof from users connecting to the communication system. The communication system may also utilize, access, and/or otherwise interact with external devices, such as the external device 106 and/or the external server 114 to retrieve data (e.g., sets of data corresponding to component updates) stored thereon and/or to process data from the communication system, as described herein.

In any event, the central server 104 may generally receive data corresponding to one or more communication system components (e.g., from component 112), and may process the data in accordance with one or more sets of instructions contained in the memory 104b to output any of the values/responses previously described. The central server 104 may include one or more processors 104a, the memory 104b, and a networking interface 104c. The memory 104b may include various sets of executable instructions that are configured to analyze data received at the central server 104 and analyze that data to output various values. These executable instructions include, for example, a machine learning module 104b1 and a machine learning chatbot 104b2.

The machine learning chatbot 104b2 may generally be an artificial intelligence (AI) trained conversational algorithm/model that is configured to interact with a user that is accessing the communication system. As a general example, when a user calls and/or otherwise accesses the central server 104 (e.g., via web-based chat, social media, text messaging, etc.), the user's verbal inputs/responses may be analyzed by the machine learning chatbot 104b2 to generate outputs, such as textual transcriptions, intent interpretations, stylistic/contextual interpretations, and/or predicted responses to such transcriptions/interpretations. In particular, the machine learning chatbot 104b2 may utilize the initial outputs (e.g., textual transcriptions, intent interpretations, and/or stylistic/contextual interpretations) to generate subsequent responses (e.g., error diagnoses, update indications, etc.) that are transmitted and displayed/conveyed to the user through the external device 106.

As a more specific example, a user may call in to the communication system, and the user may proceed to verbally communicate their requests to the communication system. In this example, the external device 106 may be and/or include the user's cellphone, telephone, microphone connected to a computing device, and/or any other suitable device(s) or combinations thereof. These verbal inputs may be routed through the network 116 to the central server 104, where the machine learning chatbot 104b2 may analyze the verbal inputs to generate initial outputs (e.g., textual transcriptions, intent interpretations, stylistic/contextual interpretations, etc.). The machine learning chatbot 104b2 may then analyze these initial outputs to determine a predicted response that may address the user's request(s). The machine learning chatbot 104b2 may repeatedly/iteratively perform this response generation until the user terminates the communication stream (e.g., hangs up the phone, disconnects from the website, etc.) and/or until the user receives and confirms satisfactory responses to their requests, when the central server 104 may automatically terminate the communication stream.

As another example, the external device 106 may be or include a social media platform configured to distribute social media posts to users connected to the platform. The social media platform may receive, and subsequently transmit, a post from a first account that includes update data 106b1 to users following and/or otherwise monitoring the first account. This post may be routed through the network 116 to the central server 104, where the machine learning chatbot 104b2 may analyze the post to generate initial outputs (e.g., textual transcriptions, intent interpretations, stylistic/contextual interpretations, etc.). The machine learning chatbot 104b2 may then analyze these initial outputs to determine an update indication that may reflect the update data 106b1 included as part of the post.

The central server 104 may be configured to receive and/or otherwise access data from various devices (e.g., communication system component 112, workstation 110), and may utilize the processor(s) 104a to execute the instructions stored in the memory 104b to analyze and/or otherwise process the received data. As an example, the central server 104 may receive an set of data corresponding to the communication system from the external device 106. The set of data may include and/or otherwise reference the update data 106b1 generated and/or otherwise stored in memory 106b of the external device 106. Accordingly, the central server 104 may utilize the processor(s) 104a to execute the machine learning chatbot 104b2 stored in the memory 104b to generate an update indication based upon the set of data received from the external device 106. The central server 104 may then, for example, transmit and/or otherwise cause the update indication to be displayed/conveyed for a user/operator by the workstation 110 for interpretation and proactive preparations for the indicated update(s).

In some embodiments, the workstation 110 and/or the communication system component 112 may include configuration data 110c1, 112c1 corresponding to updates for the component 112. The configuration data 110c1, 112c1 may be, include, and/or otherwise represent data for determining updates for the corresponding communication system component. For example, the configuration data 110c1, 112c1 may indicate whether or not a particular update may apply to the component, when the update should be applied to the component (e.g., online, offline), how the update should be applied to the component (e.g., template format), and/or any other suitable values or combinations thereof. In other words, the central server 104 may utilize this configuration data 110c1, 112c1 as a basis of comparison for the received update data to determine how/why such an update may be applicable to the particular component.

In certain embodiments, the central server 104 and/or the workstation 110 may format and/or otherwise pre-process the update data 106b 1 from the external device 106 to generate formatted update data for input to the machine learning chatbot 104b2. For example, the central server 104 may receive raw update data 106b1 from the external device 106, and may proceed to pre-process (e.g., generate formatted update data) the raw update data 106b1 with the processor(s) 104a. The resulting formatted update data may adhere to a standardized input format for the machine learning chatbot 104b2 to improve the resulting output by highlighting and/or otherwise accentuating the relevant words/phrases/characters in the update data 106b1.

For example, the central server 104 may utilize update template data 104b3 to format/pre-process the update data 106b1. The update template data 104b3 may include, for example, instructions that cause the processor(s) 104a to identify and extract device (e.g., subsystem/component) identification information, update information, timestamp information, and/or any other information included as part of the update data 106b1, and to format the extracted information into a natural language prompt for input to the machine learning chatbot 104b2. In certain embodiments, the workstation 110 may receive the raw update data 106b1 and may proceed to format the raw update data 106b1 in accordance with the update template data 104b3 prior to transmitting the formatted update data to the central server 104 for further processing via the machine learning chatbot 104b2.

In some embodiments, the central server 104 may include user profile data 104b4 that may include multiple user profiles that each indicate respective communication preferences (e.g., communication channels, stylistic preferences, etc.) for users. The central server 104 may receive an initial communication from the external device 106 when establishing a communication stream across a communication channel, and this initial communication may include data corresponding to a particular user profile. The central server 104 may then access/retrieve the corresponding data from the user profile data 104b4 to establish and communicate with a user according to their preferences. Moreover, the central server 104 may automatically instruct the machine learning chatbot 104b2 to generate responses in accordance with the user profile data 104b4 during the live communication with the user across the communication channel.

For example, data stored as part of the user profile data 104b4 corresponding to a first user may indicate that the first user prefers to talk over a telephone communication channel, and prefers a stoic conversational tone. In this example, the central server 104 may receive an initial communication across a web-based chat communication channel from an external device 106 corresponding to the first user, and the central server 104 may execute the machine learning chatbot 104b2 to generate an initial communication to the user asking whether the first user would prefer to discuss their inquiries via a phone call. As the conversation progresses, the central server 104 may execute the machine learning chatbot 104b2 in a manner that generates stoic responses to the first user's inquiries, per the user profile data 104b4 associated with the first user. However, if the tone or context of the conversation changes, the central server 104 may execute the machine learning chatbot 104b2 to generate responses that account for such changes. Thus, the central server 104 may utilize the user profile data 104b4 to generate responses/communications for the first user (e.g., via the machine learning chatbot 104b2) that correspond to the first user's preferences, and that may intelligently evolve/change to match the tone/style/context of the conversation.

Additionally, or alternatively, the user profile data 104b4 may indicate which services (e.g., textual transcription, intent interpretation, stylistic/contextual interpretation, etc.) that are performed by the machine learning chatbot 104b2 a particular user prefers to have applied to their inquiries transmitted across a communication channel to the central server 104. For example, the user profile for a second user may indicate that the second user prefers to discuss inquiries with a live agent, and does not want any services from the machine learning chatbot 104b2. Of course, any user may have or include any suitable number of preferences as part of the user profile data 104b4, and the user profile data 104b4 may include any suitable number of services provided by the machine learning chatbot 104b2.

As another example, the central server 104 may receive a set of data from a source external to the communication system (e.g., external device 106, external server 114), the set of data corresponding to updates to a communication system component (e.g., communication system component 112). The central server 104 may execute the machine learning chatbot 104b2 to determine that the set of data (e.g., update data 106b1) corresponds to such updates, and the server 104 may further utilize the machine learning chatbot 104b2 to generate an update indication corresponding to the set of data. For example, the update indication may include which communication system component is receiving an update, when the update is scheduled to take place, how long the update may take, and/or any other suitable information or combinations thereof. The central server 104 may then transmit and/or otherwise cause the update indication to be displayed/conveyed for a user/operator by the workstation 110 for interpretation and/or review of a generated template based upon the update indication.

As yet another example, the central server 104 may receive a user query from a user (e.g., via external device 106) requesting information from the communication system. The central server 104 may execute the machine learning chatbot 104b2 to determine a stylistic scheme and/or a contextual scheme for a response to the user query, and the server 104 may further utilize the machine learning chatbot 104b2 to generate a response to the user query that is articulated in accordance with the stylistic scheme and/or the contextual scheme. The stylistic scheme may represent how a user generally conveys information (e.g., informally, tons of colloquialisms, short/long sentences), and as such, the stylistic scheme may inform how the machine learning chatbot 104b2 formats answers in a manner that closely mimics the user's preferred communication style. Similarly, the contextual scheme may represent the subject matter of the conversation (e.g., personal injuries, vehicle accidents) and the gravitas (or lack thereof) typically associated therewith, and/or may represent a predicted tone (e.g., happy, sad, angry, etc.) a user is using when chatting with the machine learning chatbot 104b2. Regardless, the central server 104 may then transmit and/or otherwise cause the response to be displayed/conveyed for a user/operator by the workstation 110 and/or the external device 106 for interpretation by the user/operator.

As another example, the central server 104 may connect a training module (e.g., machine learning module 104b1) to communication channel(s) of the communication system. The central server 104 may then aggregate (e.g., via the machine learning module 104b1) a set of data from a plurality of communications utilizing the communication channel(s) of the communication system. The central server 104 may then execute the machine learning module 104b1 to train the machine learning chatbot 104b2 with the set of data from the plurality of communications to generate a plurality of training responses to hypothetical prompts. The central server 104 may then connect the machine learning chatbot 104b2 to live communication channel(s) to generate predicted responses to live prompts received across the live communication channel(s). For example, the communication channel may be or include a telecommunication channel, a web-based chat channel, a video channel, and/or any other suitable communication channel or combinations thereof.

In order to execute these or other instructions stored in memory 104b, the central server 104 may communicate with a workstation 110. The workstation 110 may generally be any computing device that is communicatively coupled with the central server 104, and more particularly, may be a computing device with administrative permissions that enable a user accessing the workstation 110 to update and/or otherwise change data/models/applications that are stored in the memory 104b. For example, the workstation 110 may enable a user to access the central server 104, and the user may train the machine learning chatbot 104b2 that is stored in the memory 104b. As discussed herein, in certain embodiments, the machine learning chatbot 104b2 may be trained by and may implement machine learning techniques. In these embodiments, the user accessing the workstation 110 may upload training data, execute training sequences to train the chatbot 104b2, and may update/re-train the chatbot 104b2 over time. The workstation 110 may include one or more processors 110a, a networking interface 110b, a memory 110c, and a display 110d.

In some embodiments, the central server 104 may store and execute instructions that may generally train the machine learning chatbot 104b2 stored in the memory 104b. For example, the central server 104 may execute instructions included as part of the machine learning module 104b1 that are configured to train the machine learning chatbot 104b2 to output an error diagnosis, an update indication, a response to a user query articulated in accordance with a stylistic/contextual scheme, responses to live prompts across a communication channel of the computing system 100, and/or any other values, responses, or combinations thereof.

In particular, the training dataset(s) may include a plurality of training error indications as inputs and/or a plurality of training error diagnoses, a plurality of training data corresponding to the communication system and/or a plurality of training update indications, a plurality of training user queries and/or a plurality of training responses, a plurality of training sets of data corresponding to the communication system and/or a plurality of training responses, and/or any other suitable data and combinations thereof. However, in certain embodiments, the machine learning chatbot 104b2 may be a rules-based algorithm configured to receive error indications, data corresponding to the communication system, and/or user queries as input and to output error diagnoses, update indications, and/or responses as output.

In some embodiments, the machine learning chatbot 104b2 may be configured to utilize artificial intelligence and/or machine learning techniques. For instance, the machine learning chatbot 104b2 may be a ChatGPT chat bot. The machine learning chatbot 104b2 may employ supervised or unsupervised machine learning techniques, which may be followed or used in conjunction with reinforced or reinforcement learning techniques. The machine learning chatbot 104b2 may employ the techniques utilized for ChatGPT.

Noted above, in some embodiments, the machine learning chatbot 104b2 or other computing device may be configured to implement machine learning, such that the central server 104 “learns” to analyze, organize, and/or process data without being explicitly programmed. Machine learning may be implemented through machine learning methods and algorithms. In one exemplary embodiment, a machine learning module may be configured to implement machine learning methods and algorithms.

In some embodiments, at least one of a plurality of machine learning methods and algorithms may be applied, which may include but are not limited to: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of a plurality of categorizations of machine learning, such as supervised learning, unsupervised learning, and reinforcement learning.

In one embodiment, the machine learning chatbot 104b2 employs supervised learning, which involves identifying patterns in existing data to make predictions about subsequently received data. Specifically, the machine learning chatbot 104b2 may be “trained” using training data, which includes example inputs and associated example outputs. Based upon the training data, the machine learning chatbot 104b2 may generate a predictive function which maps outputs to inputs and may utilize the predictive function to generate machine learning outputs based upon data inputs. The example inputs and example outputs of the training data may include any of the data inputs or machine learning outputs described above. In the exemplary embodiment, a processing element may be trained by providing it with a large sample of data with known characteristics or features.

In another embodiment, the machine learning chatbot 104b2 may employ unsupervised learning, which involves finding meaningful relationships in unorganized data. Unlike supervised learning, unsupervised learning does not involve user-initiated training based upon example inputs with associated outputs. Rather, in unsupervised learning, the machine learning chatbot 104b2 may organize unlabeled data according to a relationship determined by at least one machine learning method/algorithm employed by the machine learning chatbot 104b2. Unorganized data may include any combination of data inputs and/or machine learning outputs as described above.

In yet another embodiment, a machine learning chatbot 104b2 may employ reinforcement learning, which involves optimizing outputs based upon feedback from a reward signal. Specifically, the machine learning chatbot 104b2 may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

As an example, the machine learning chatbot 104b2 may employ natural language processing (NLP) functions, which generally involves understanding verbal/written communications and generating responses to such communications. The machine learning chatbot 104b2 may be trained to perform such NLP functionality using a symbolic method, machine learning models, and/or any other suitable training method. As an example, the machine learning chatbot 104b2 may be trained to perform at least two techniques that may enable the machine learning chatbot 104b2 to understand words spoken/written by a user: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (POS) tagging, parsing, lemmatization and stemming, stop-word removal, and/or any other suitable sub-task or combinations thereof. For example, using syntactic analysis, the machine learning chatbot 104b2 may generate textual transcriptions from verbal responses from a user in a data stream.

Semantic analysis generally involves analyzing text in order to understand and/or otherwise capture the meaning of the text. In particular, the machine learning chatbot 104b2 applying semantic analysis may study the meaning of each individual word contained in a textual transcription in a process known as lexical semantics. Using these individual meanings, the machine learning chatbot 104b2 may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the machine learning chatbot 104b2 may generate one or more intent interpretations based upon one or more textual transcriptions from a syntactic analysis.

After training, machine learning programs (or information generated by such machine learning programs) may be used to evaluate additional data. Such data may be and/or may be related to communication system component data, communication channel data, user device data, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset. Such trained machine learning programs may, therefore, be used to perform part or all of the analytical functions of the methods described elsewhere herein.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that, as previously mentioned, the machine learning chatbot 104b2 may be used to output an error diagnosis, an update indication, a response to a user query articulated in accordance with a stylistic/contextual scheme, responses to live prompts across a communication channel of the computing system 100, and/or any other values, responses, or combinations thereof using artificial intelligence (e.g., a machine learning model of the machine learning chatbot 104b2) or, in alternative aspects, without using artificial intelligence.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

In any event, the central server 104 may execute the machine learning chatbot 104b2 to generate an update indication that indicates a potential update to at least one component of the communication system (e.g., communication system component 112). The central server 104 may then transmit the update indication to the workstation 110 for display to a user/operator. Moreover, in certain embodiments, the central server 104 may also initiate communication between the workstation 110 and the communication system component (e.g., component 112) that is indicated in the update indication. In this manner, the user/operator may seamlessly begin preparatory operations for the communication system component upon receipt of the update indication.

As previously mentioned, the external device 106 may be or include a media platform (e.g., social media platform, website, etc.) configured to distribute social media posts to users connected to the platform. However, more generally, the external device 106 may be or include any device that is associated with (e.g., configured to connect with, etc.) a particular user, who may post and/or otherwise provide data that may be transmitted to the communication system through the network 116. In certain embodiments, the external device 106 may be a personal computing device of that user, such as a smartphone, a tablet, smart glasses, or any other suitable device or combination of devices (e.g., a smart watch plus a smartphone) with wireless communication capability. Thus, the update data 106b1 stored in memory 106b may also be a post or other information contributed by the external device 106 to a social media platform or other networked system/platform where the data 106b1 may be transmitted through the network 116 to the central server 104. In the embodiment of FIG. 1, the external device 106 may include a processor 106a, a memory 106b, a networking interface 106c, and a display 106d.

The external device 106 may be communicatively coupled to the central server 104, the workstation 110, the communication system component 112, and/or the external server 114. For example, the external device 106 and the central server 104, the workstation 110, the communication system component 112, and/or the external server 114 may communicate via USB, Bluetooth, Wi-Fi Direct, Near Field Communication (NFC), etc. For example, the central server 104 may transmit an error diagnosis, a response to a user query articulated in accordance with a stylistic/contextual scheme, responses to live prompts across a communication channel of the computing system 100, and/or any other values, responses, or combinations thereof to the external device 106 via the networking interface 104c, which the external device 106 may receive via the networking interface 106c.

The communication system component 112 may generally be or include any suitable type of component that may facilitate and/or otherwise be configured to perform functions that enable the processing/transmission of communications across various communication channels. For example, a communication system component 112 may be a switch, a router, a telephone service, a cloud-based service, a software package, a website, and/or any other suitable components of a communication system. Further, the communication system component 112 may be communicatively coupled to the network 116, as well as directly connected (e.g., via an internal network) to the workstation 110 and/or the central server 104. The communication system component 112 may include a processor 112a, a networking interface 112b, a memory 112c, and a set of configuration data 112c1 stored in the memory 112c.

The external server 114 may be or include computing servers and/or combinations of multiple servers storing data that may be accessed/retrieved by the central server 104, the external device 106, the workstation 110, and/or the communication system component 112. The data stored by the external server 114 may include a machine learning chatbot 114c1 that is configured to generate similar outputs to the machine learning chatbot 104b2. In certain embodiments, the external server 114 may receive data from the central server 104, the external device 106, the workstation 110, and/or the communication system component 112, and may execute the machine learning chatbot 114c1 to generate the outputs described herein. The external server 114 may include a processor 114a, a networking interface 114b, and a memory 114c that includes the machine learning chatbot 114c1.

Each of the processors 104a, 106a, 110a, 112a, 114a may include any suitable number of processors and/or processor types. For example, the processors 104a, 106a, 110a, 112a, 114a may include one or more CPUs and one or more graphics processing units (GPUs). Generally, each of the processors 104a, 106a, 110a, 112a, 114a may be configured to execute software instructions stored in each of the corresponding memories 104b, 106b, 110b, 112c, 114c. The memories 104b, 106b, 110b, 112c, 114c may include one or more persistent memories (e.g., a hard drive and/or solid state memory) and may store one or more applications, modules, and/or models, such as the machine learning module 104b1 and/or the machine learning chatbot 104b2.

The networking interface 104c may enable the central server 104 to communicate with the workstation 110, the external device 106, the communication system component 112, the external server 114, and/or any other suitable devices or combinations thereof. More specifically, the networking interface 104c enables the central server 104 to communicate with each component of the exemplary computing system 100 across the network 116 through their respective networking interfaces 106c, 110b, 112b, 114b. The networking interface 104c may support wired or wireless communications, such as USB, Bluetooth, Wi-Fi Direct, Near Field Communication (NFC), etc. The networking interface 104c may enable the central server 104 to communicate with the various components of the exemplary computing system 100 via a wireless communication network such as a fifth-, fourth-, or third-generation cellular network (5G, 4G, or 3G, respectively), a Wi-Fi network (802.11 standards), a WiMAX network, a wide area network (WAN), a local area network (LAN), etc.

Moreover, the network 116 may be a single communication network, or may include multiple communication networks of one or more types (e.g., one or more wired and/or wireless personal or local area networks (PANs or LANs), and/or one or more wide area networks (WANs) such as the Internet). In some embodiments, the network 116 includes multiple, entirely distinct networks (e.g., one or more networks for communications between central server 104 and external device 106, and a separate, Bluetooth or wireless LAN (WLAN) network for communications between central server 104 and workstation 110, and so on).

It will be understood that the above disclosure is one example and does not necessarily describe every possible embodiment. As such, it will be further understood that alternate embodiments may include fewer, alternate, and/or additional steps or elements.

### Exemplary Workflows for a Computing Device

FIG. 2A, depicts a first exemplary workflow 200 for data input/output of a computing device (e.g., the central server 104) of FIG. 1, in accordance with various embodiments described herein. The first exemplary workflow 200 generally illustrates various data received/retrieved by the central server 122 that is utilized by the machine learning chatbot 122b2 as inputs to generate various outputs. The various data received/retrieved by the central server 122 includes update data, configuration data, communication system documentation, update template data, user profile data, and/or user inputs. The outputs generated by the machine learning chatbot 122b2 based upon the received/retrieved data includes an update indication. As illustrated in FIG. 2A, the central server 122 includes a processor 122a, a memory 122b, a machine learning module 122b1, a machine learning chatbot 122b2, and a networking interface 122c.

As previously described, the update data, configuration data, communication system documentation, update template data, user profile data, and/or user inputs received/retrieved by the central server 122 may include a large variety of specific information/data. For example, the update data may be or include textual data and/or other character strings that may indicate an update corresponding to a specific communication system subsystem/component, timing information indicating when the update may be available/pushed to the specific communication system subsystem/component, and/or any other suitable information or combinations thereof. The configuration data may be, include, and/or otherwise represent data for determining updates for the corresponding communication system component. For example, the configuration data may indicate whether or not a particular update may apply to the component, when the update should be applied to the component (e.g., online, offline), how the update should be applied to the component (e.g., template format), and/or any other suitable values or combinations thereof. The communication system documentation may be or include written or verbal documentation describing communication system subsystem/component errors and/or solutions to such errors, and/or any other suitable data or combinations thereof.

The update template data may be or include instructions that cause the processor(s) 122a to identify and extract device (e.g., subsystem/component) identification information, update information, timestamp information, and/or any other information included as part of the update data 106b1. In particular, the update template data may instruct the processor(s) 122a identify and extract the update data in accordance with one or more update templates that correspond to one or more subsystems/components of the communication system. For example, a first update template corresponding to a first communication system component may require a first data entry and a second data entry, while a second update template corresponding to a second communication system component may require the first data entry and a third data entry.

The user profile data may be or include data indicating respective communication preferences (e.g., communication channels, stylistic preferences, etc.) for users, and/or any other suitable data or combinations thereof. The user input may be or include data corresponding to user/operator feedback regarding accuracy/relevance of outputs from the machine learning chatbot 122b2, and/or any other suitable data or combinations thereof.

Using this data as input, the machine learning chatbot 122b2 and/or other instructions stored in memory 122b may determine the update indication. Of course, in certain instances, the central server 122 may not receive any configuration data, communication system documentation, update template data, user profile data, and/or user input. In these instances, the central server 122 may receive only the update data corresponding to a particular communication system subsystem/component, and may generate the update indication for the particular update.

As mentioned, the update indication may generally include a predicted update to at least one component of the communication system based upon the update data. The predicted update may be or include an indication of a particular communication system subsystem/component (e.g., communication system component 112) that may receive/require the update, and may indicate why the particular subsystem/component is receiving the update. For example, an update indication for a first update may indicate that a processing component of the communication system is currently unable to process data received across a first communication channel due to a software issue. Thus, the update indication may indicate that the first update may eliminate this data processing issue by updating the software for the processing component of the communication system.

The update indication may also be or include an indication of a particular action or series of actions that a user/operator may take to ensure that the update is applied successfully. For example, an update indication for a second update may indicate a specific time when the second update is available for download/application so that the user/operator may download the software update/patch at the specific time. In another example, the update indication for a third update may include a predicted update methodology indicating that the user/operator should apply the update to the particular communication system subsystem/component while the particular subsystem/component is offline.

Additionally, as part of generating the update indication, the machine learning chatbot 122b2 may be or include an update template associated with the update indication. The update template may be or include data from the update data and/or update template data that the user/operator may need to obtain prior to applying an update to a communication system subsystem/component. For example, an update template (and correspondingly the update template data) may include fields to identify the particular subsystem/component corresponding to the update, a purpose of the update, date/time of the update application/installation/etc., and/or any other suitable data or combinations thereof. Accordingly, the machine learning chatbot 122b2 may receive the update data and/or the update template data, and may output a completed and/or otherwise partially completed update template along with and/or as part of the update indication. The user/operator may receive the update template, and may review the template prior to storing the template.

Practically speaking, the machine learning chatbot 122b2 may output the update indication as a set of classification values that have associated confidence value(s)/interval(s). For example, the update indication may include a predicted update for a first routing component with a confidence value of 80%, and a predicted time for the update to install/apply to the first routing component with a confidence value of 75%. Of course, the update indication may be or include predicted update(s), predicted release date(s)/time(s), predicted installation/application time(s) indicated in any suitable manner, such as a single numerical value (e.g., 1, 2, 3, etc.), a confidence interval, a percentage (e.g., 95%, 50%, etc.), an alphanumerical character(s) (e.g., A, B, C, etc.), a symbol, and/or any other suitable value or indication of a likelihood that the update indication is accurate.

In some embodiments, the machine learning chatbot 122b2 may output the update indication as a set or list of classification values corresponding to the likely predicted update(s) for a particular subsystem/component. For example, the machine learning chatbot 122b2 may output an update indication for a first component indicating that the predicted updates for the first component are: a software update with a confidence value of 90%, a firmware update with a confidence value of 50%, and a hardware update with a confidence value of 15%. In this example, the machine learning chatbot 122b2 may output the update indication for the first component indicating that the predicted release date for the predicted update(s) are: within the next twenty days with a confidence value of 92%, within the next fifteen days with a confidence value of 55%, and within the next eight days with a confidence value of 33%.

In some embodiments, the central server 122 may also receive the configuration data in addition to the update data. In these embodiments, the machine learning chatbot 122b2 may output the update indication based upon both the update data and the configuration data. The machine learning chatbot 122b2 may interpret the configuration data for a component to determine, for example, whether or not a particular update may apply to the component, when the update should be applied to the component (e.g., online, offline), how the update should be applied to the component (e.g., template format), and/or any other suitable values or combinations thereof. Thus, the machine learning chatbot 122b2 may use the configuration data as a basis for comparison with the update data to determine if the update data generally includes sufficient detail to determine whether/how/when a particular update may apply to a particular subsystem/component.

In certain embodiments, the central server 122 may also receive the communication system documentation in addition to the update data. In these embodiments, the machine learning chatbot 122b2 may output the update indication based upon both the update data and the communication system documentation. The machine learning chatbot 122b2 may interpret the update data and the communication system documentation to extract or infer an update indication based upon the data contained in the update data and the communication system documentation. Namely, the update indication may include a predicted update to a communication system subsystem/component that is extracted and/or inferred directly from communication system documentation related to the subsystem/component.

For example, the machine learning chatbot 122b2 may receive a update data indicating a second update associated with a communication system component (e.g., communication system component 112), and the communication system documentation may be or include a maintenance document that includes specification information related to the communication system component. The machine learning chatbot 122b2 may interpret the update data to determine that the second update is associated with the communication system component, and the chatbot 122b2 may subsequently interpret the communication system documentation to determine relevant information corresponding to the communication system component and the second update. The chatbot 122b2 may, for example, attempt to locate keywords from the update data in the communication system documentation to provide an update indication that has explicit support within the documentation. In circumstances, where the machine learning chatbot 122b2 is able to locate such explicit support (or less explicit support), the chatbot 122b2 may provide a citation or other reference to the communication system documentation as part of the update indication.

As an example, the machine learning chatbot 122b2 may receive update data indicating that a first communication system subsystem has an update scheduled for release in one week. The update data may also indicate that the update applies to software running and/or otherwise executed by the first communication system subsystem. The machine learning chatbot 122b2 may then analyze the communication system documentation to determine information regarding processing/memory resources (e.g., available storage resources) of the first communication system subsystem. As a result of the analysis, the machine learning chatbot 122b2 may determine that the first communication system subsystem has sufficient memory capacity to receive/store the software update. Therefore, the machine learning chatbot 122b2 may output an update indication indicating that the update may be successfully downloaded/stored/applied to the first communication system subsystem at the date/time of release.

Additionally, in certain circumstances, the machine learning chatbot 122b2 may receive the update data and the user profile data. In these circumstances, the machine learning chatbot 122b2 may generate an update indication that predicts update(s) to the communication system subsystem(s)/component(s) while accounting for the user preferences contained within the user profile data. For example, the machine learning chatbot 122b2 may receive update data indicating that a component/subsystem of a telephonic subsystem of the communication system has a software update scheduled for release in two weeks. The machine learning chatbot 122b2 may thereafter retrieve user profile data of a user/operator that is assigned for management, operation, etc. of the telephonic subsystem, and may interpret the user profile data to determine that the user typically prefers predicted updates formatted into a standard update template. Consequently, the machine learning chatbot 122b2 may generate an update indication corresponding to predicted update(s) for the telephonic subsystem that includes an update template, in accordance with the user profile data.

In some embodiments, the central server 122 may also receive the user input in addition to the error indication. This user input may be or include any suitable data/information, and may specifically include feedback from a user/operator regarding the accuracy of the predicted update(s), template(s), and/or other information provided in the update indication. For example, the machine learning chatbot 122b2 may output an update indication that may accurately identify the predicted update and the associated communication system subsystem/component, but may suggest a predicted installation/application date/time that is non-optimal. The user/operator evaluating the update indication may recognize the accuracy of the predicted update and the inaccuracy of the predicted installation/application date/time, and may provide input to the machine learning chatbot 122b2 that may update/re-train the chatbot 122b2 to improve subsequent update indications. As a result of the user input, the machine learning chatbot 122b2 may continue to accurately identify similar/identical updates and may more accurately predict optimal installation/application date(s)/time(s) for identical/similar updates during subsequent iterations.

FIG. 2B, depicts a second exemplary workflow 220 for data input/output of a computing device (e.g., the central server 104) of FIG. 1, in accordance with various embodiments described herein. In particular, the second exemplary workflow 220 broadly illustrates an example update indication generation sequence, in which the machine learning chatbot 122b2 may receive a prompt, determine/extract embeddings from the prompt, compare those embeddings to an embedding dictionary 226, and generate the update indication. Of course, this update indication generation sequence illustrated in FIG. 2B is for the purposes of discussion only, and additional/alternative update indication generation sequences utilizing additional/alternative machine learning techniques may also be utilized.

At a first time instance 222, the machine learning chatbot 122b2 may receive a prompt, which may be or may include update data. The prompt may typically include a character string that represents data for processing by the machine learning chatbot 122b2. For example, the prompt may include update data from an external device (e.g., external device 106) that is included as part of the prompt. Additionally, or alternatively, the prompt may include written/transcribed natural language from a user. This natural language included in the prompt may, for example, represent data relate to/taken from the configuration data, communication system documentation, update template data, user profile data and/or other user input(s) that may influence the resulting update indication output by the machine learning chatbot 122b2.

As one example, the prompt may include update data representing an update scheduled for release for a first subsystem of the communication system that includes four components. The prompt may also include a user input indicating that the user has determined that the update is not configured for installation/application with a first or a second component of the first subsystem. Thus, the machine learning chatbot 122b2 may utilize the update data and the user input to focus the determination of predicted update(s) for the first subsystem by eliminating the first and second components as potential components requiring and/or otherwise corresponding to the update.

When the machine learning chatbot 122b2 receives the prompt, the machine learning chatbot 122b2 may then proceed to interpret the prompt in a manner consistent with the machine learning techniques used to train the chatbot 122b2, as discussed herein. As illustrated in FIG. 2B, one such interpretation may be to segment the prompt into various character strings that have corresponding embeddings. Individual words, data sequences, and/or other character sets may have or receive particular embeddings that represent an n-dimensional value, where each coordinate value or “item” of the embedding may be associated with a particular characteristic of the character set, and n may be any suitable integer value. For example, embedding A may be an n-dimensional value corresponding to a first character set in the prompt, embedding B may be an n-dimensional value corresponding to a second character set in the prompt, and embedding N may be an n-dimensional value corresponding to a last character set in the prompt. In any event, the machine learning chatbot 122b2 may generate a set of embeddings for some/all of the data included as part of the prompt.

At a second time instance 224, the machine learning chatbot 122b2 may compare each of the embeddings to an embedding dictionary 226 to determine associations between the prompt and similar prompts, and by proxy, corresponding update indications associated with those similar prompts. More specifically, the machine learning chatbot 122b2 may reference the embeddings stored in the embedding dictionary 226 to determine embeddings that are “close” to the embeddings of the prompt. This measure of closeness may be determined by calculating, for example, a geometric distance between two embeddings within the corresponding n-dimensional space. Each embedding may be compared to the embeddings in the embedding dictionary 226 in this manner, and the machine learning chatbot 122b2 may determine one or more embeddings from the dictionary 226 that are the closest to the embeddings from the prompt.

In certain embodiments, the embeddings in the embedding dictionary 226 may be associated with prior update data and/or update indications. Namely, the embedding dictionary 226 may include and/or reference a storage location where the associated prior update data and/or update indications are stored to enable the machine learning chatbot 122b2 to reference and/or otherwise utilize these prior update data and/or update indications when generating a new update indication based upon an input prompt. The machine learning chatbot 122b2 may thereby determine that embeddings from a prompt that are relatively close (in the n-dimensional space) to a first set of embeddings in the embedding dictionary 226 may be associated with a similar update, communication system subsystem/component, and/or other data.

Consequently, the machine learning chatbot 122b2 may generate an update indication that includes predicted update(s) based upon the comparison of the prompt embeddings to the embedding dictionary 226. For example, the machine learning chatbot 122b2 may determine that the embeddings from the prompt are relatively close (in the n-dimensional space) to embeddings in the embedding dictionary 226 that are associated with a first update to a first communication system subsystem/component. The machine learning chatbot 122b2 may then access prior update data and/or update indications corresponding to the first update and/or the first communication system subsystem/component to determine an update indication that most accurately reflects the circumstances indicated in the update data included in the prompt.

### Exemplary Graphical User Interfaces (GUIs)

FIG. 3 depicts an exemplary graphical user interface (GUI) 300 that may be displayed on a computing device (e.g., workstation 110 of FIG. 1), in accordance with various embodiments described herein. Generally, the exemplary GUI 300 may allow a user to interact with the central server 104, which may include receiving outputs from the central server 104 or sending inputs to the central server 104, as described in reference to the first exemplary workflow 200 of FIG. 2A. The exemplary GUI 300 thus provides the user with a designated place to remain informed regarding the functioning of a communication system configured to establish, maintain, and perform communication activities between/among various devices (e.g., external device 106). In particular, the exemplary GUI 300 may display information, values, maps, contact information, and/or other data related to update data/update indications for subsystems/components of a communication system.

Namely, the exemplary GUI 300 may include an update display hub 312, an update data hub 318, an update indication hub 320, and a communication system map hub 322. The update display hub 312 may include a predicted update installation/application indication 313, a predicted update installation/application value 314, a component documentation access button 315, and a component interface platform button 316. The user may directly interact (e.g., click, swipe, tap, gesture, voice command, etc.) with the component documentation access button 315, and the component interface platform button 316 to initiate additional actions that may direct the user away from the first exemplary GUI 300.

For example, interacting with the component documentation access button 315 may cause the workstation 110 to load and render and/or otherwise cause the user to view one or more documents related to the communication system component/subsystem indicated in the update indication. The user may view the one or more documents on the workstation 110 display, and in certain embodiments, the relevant portions of the one or more documents may be highlighted and/or otherwise marked for specific reference by the user. In this manner, the user may direct their attention to the relevant portions of the documents that may have influenced the update indication provided in the update data hub 318 and the update indication hub 320. The user may read the one or more documents, and may independently validate the update indication and/or otherwise check that the machine learning chatbot 122b2 is accessing/referencing relevant information when generating update indications for a particular subsystem/component of the communication system.

Additionally, interacting with the component interface platform button 316 may cause the workstation 110 to initiate a communication between the workstation 110 and the subsystem/component (e.g., communication system component 112) of the communication system indicated in the update indication. In other words, when the user interacts with the component interface platform button 316, the workstation 110 may automatically exit and/or close the exemplary GUI 300, and the workstation 110 may open and/or otherwise activate a communication system application or function, initiate communication with the subsystem/component, and thereby enable the user to communicate directly with the subsystem/component for analysis. The user may then attempt to, for example, perform one or more of the actions specified as part of the update indication (e.g., as provided in the update indication hub 320) to install/apply and/or proactively prepare for the update installation/application.

The predicted update installation/application indication 313 and predicted update installation/application value 314 may generally correspond to an estimated time required to install/apply the update indicated in the update data/indication. In this manner, the user may view the predicted update installation/application value 314 and understand approximately how long the update indicated in the update data/indication may take to apply/install. In certain embodiments, the predicted update installation/application value 314 may be based upon prior installation/application times for identical/similar updates. The user may then ideally initiate installation/application actions at a time when the update may install/apply within the period specified by the predicted update installation/application value 314 while placing a minimal burden on communication system subsystems/components. For example, if a first update requires a component to be taken offline for 30 minutes to receive the appropriate update, the user may view the 30 minute predicted time in the predicted update installation/application value 314, and may schedule and/or initiate the offline update installation at a time when such offline update installation would minimally impact the online functionality of the communication system.

Both of the update data hub 318 and the update indication hub 320 may provide instructions, values, recommendations, and/or other indications to a user related to data processed by the central server 104. For example, as illustrated in FIG. 3, the update data hub 318 states that “[t]he update data represents a likely update to critical software for an audio processing component. According to the update data, the update may not be released for one to two weeks. Thus, it is predicted that a software update for the audio processing components may be available for implementation within two weeks.” The user may view the predicted update(s) of the update indication in the update data hub 318, and the user may check the audio processing components for optimal operating conditions to ensure that the components are prepared for the update in two weeks. The user may test the audio processing components by, for example, simulating an incoming audio data stream, and may specifically monitor the audio processing/analysis performed by the components to verify that the analysis and/or interpretation performed by the components is appropriate and/or otherwise correct.

As another example, and as illustrated in FIG. 3, the update indication hub 320 states that “[b]ased on the update data provided, the software update may resolve certain issues related to choppy and/or dropped communications, and should be applied as soon as possible. The update may require up to 30 minutes to apply, so it is recommended to apply the update during offline hours or during a period of low anticipated call volume.” The user may view the predicted update specifics in the update indication hub 320, and the user may evaluate how the software updates should be installed/applied for the audio data processing components. In this manner, the update indication may guide the user to an optimal update application/installation methodology based upon the information included in the update data hub 318 and/or the update indication hub 320.

The communication system map hub 322 may generally represent operating conditions of various communication system subsystems/components 322a-h, at least one of which, may have an upcoming, currently installing/applying, and/or otherwise update indicated in the various hubs 312-322 of the exemplary GUI 300. The central server 104 may collect operating data from each of the subsystems/components 322a-h, and the central server 104 may generate the map displayed in the communication system map hub 322.

For example, the map in the communication system map hub 322 may include a plurality of communication system subsystems/components 322a-h that may each have a different corresponding operating level. In particular, as illustrated in FIG. 3, each of the first subsystem/component 322a, the second subsystem/component 322b, the fourth subsystem/component 322d, the fifth subsystem/component 322e, the sixth subsystem/component 322f, the seventh subsystem/component 322g, and the eighth subsystem/component 322h may not have an upcoming update, a currently installing update, and/or do not otherwise have a corresponding update. By contrast, the third subsystem/component 322c may have an upcoming update, a currently installing update, and/or may otherwise have a corresponding update, as indicated by the patterning within the third subsystem/component 322c. Thus, a user may view the communication system map hub 322, and may visually pinpoint the third subsystem/component 322c as having a corresponding update based upon the update indication generated by the machine learning chatbot 122b2.

Moreover, it should be understood that any update data, communication system subsystem/component data, and/or any values determined, detected, calculated, and/or otherwise output by the central server 104 may be displayed generally in the exemplary GUI 300. Additionally, or alternatively, it should be appreciated that interaction with any of the hubs or other displays in the exemplary GUI 300 may cause the workstation 110, an external device 106, and/or the central server 104 to perform other actions than those described in reference to FIG. 3. For example, a user interacting with the component interface platform 316 may cause the workstation 110 to transmit a signal to the communication system subsystem/component to cause the subsystem/component to perform one or more actions that may prepare the subsystem/component to receive the update. Of course, this example is for illustration purposes only, and other actions/signals described herein may be transmitted, relayed, and/or otherwise performed by the workstation 110, external device 106, and/or the central server 104 in response to a user interacting with any hub or display within the exemplary GUI 300.

### Exemplary Computer-Implemented Methods

FIG. 4 depicts a flow diagram representing an exemplary computer-implemented method 400, in accordance with various embodiments described herein. The method 400 may be implemented by one or more processors of the exemplary computing system 100, such as the central server 104, the workstation 110, the external device 106, the communication system component 112, the external server 114, and/or any other suitable components described herein or combinations thereof.

The method 400 may include retrieving, by one or more processors, a set of data corresponding to the communication system from one or more sources external to the communication system (block 402). The method 400 may further include determining, by the one or more processors executing a machine learning chatbot, that the set of data indicates a potential update to at least one component of the communication system, wherein the machine learning chatbot is trained with a plurality of training data corresponding to the communication system as inputs to generate a plurality of training update indications as outputs (block 404).

The method 400 may further include generating, by the one or more processors executing the machine learning chatbot, an update indication corresponding to the set of data (block 406). The method 400 may further include displaying, by the one or more processors, the update indication on a user interface for viewing by a user (block 408). In certain embodiments, displaying the update indication may be or include presenting, by the one or more processors and/or the machine learning chatbot, the update indication via voice or audible interaction generated by the machine learning chatbot, or presenting an audible indication corresponding to the update indication to a user via the machine learning chatbot or a speaker associated with the machine learning chatbot.

The method 400 may optionally include receiving, at the one or more processors, a user input including (i) a first indication corresponding to the predicted update associated with the at least one component of the communication system, (ii) a second indication corresponding to an impact of the predicted update to the communication system, and (iii) third indication corresponding to a time of the predicted update (block 410). The method 400 may also optionally include re-training, by the one or more processors, the ML chatbot based upon the user input (block 412).

In some embodiments, generating the update indication may further include: generating, by the one or more processors executing the ML chatbot, the update indication corresponding to the set of data and an update template associated with the update indication, wherein the update template includes data from the set of data required to process the update for the communication system. Further in these embodiments, the ML chatbot may be further trained using a plurality of training user inputs corresponding to a plurality of training update templates, and the method may further include: (i) receiving, at the one or more processors, a user input corresponding to the update indication; and (ii) generating, by the one or more processors executing the ML chatbot, the update template based upon the user input and in a style representative of the user input.

In certain embodiments, the update indication may include (i) a predicted update associated with at least one component of the communication system, (ii) a predicted impact of the predicted update, and (iii) a predicted time of the predicted update.

In some embodiments, determining that the set of data indicates a potential update may further include: (i) generating, by the one or more processors, one or more embeddings associated with the set of data; (ii) comparing, by the one or more processors, the one or more embeddings to a library of embeddings; and/or (iii) determining, by the one or more processors, that the set of data indicates a potential update based upon the comparing. Further in these embodiments, generating the update indication may further include: (i) retrieving, by the one or more processors, one or more prior update indications from an update indication database based upon the one or more embeddings; and/or (ii) generating, by the one or more processors executing the ML chatbot, the update indication based upon the set of data and the one or more prior update indications.

In certain embodiments, generating the update indication may further include: inputting, by the one or more processors, a plurality of documentation corresponding to the communication system into the ML chatbot; and/or generating, by the one or more processors executing the ML chatbot, the update indication based upon the set of data corresponding to the communication system and the plurality of documentation.

In some embodiments, the potential update to the at least one component of the communication system may corresponds to at least one of: (i) a software update, or (ii) a hardware update.

In certain embodiments, the one or more sources external to the communication system may include one or more of: (i) a social media platform, (ii) a news platform, (iii) a blog, (iv) a manufacturer website, or (v) a service provider website; and the set of data corresponding to the communication system may include one or more of: (i) a social media post, (ii) an article posted on a news platform, (iii) a blog excerpt, or (iv) a portion of the manufacturer website or the service provider website.

Of course, it is to be appreciated that the actions of the method 400 may be performed any suitable number of times, and that the actions described in reference to the method 400 may be performed in any suitable order.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other exemplary embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as

“processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for evaluation properties, through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A computer-implemented method for proactively managing updates in a communication system, the method comprising:
retrieving, by one or more processors, a set of data corresponding to the communication system from one or more sources external to the communication system;
determining, by the one or more processors executing a machine learning (ML) chatbot, that the set of data indicates a potential update to at least one component of the communication system, wherein the ML chatbot is trained with a plurality of training data corresponding to the communication system as inputs to generate a plurality of training update indications as outputs;
generating, by the one or more processors executing the ML chatbot, an update indication corresponding to the set of data; and
displaying, by the one or more processors, the update indication on a user interface for viewing by a user.

2. The computer-implemented method of claim 1, wherein generating the update indication further comprises:
generating, by the one or more processors executing the ML chatbot, the update indication corresponding to the set of data and an update template associated with the update indication,
wherein the update template includes data from the set of data required to process the update for the communication system.

3. The computer-implemented method of claim 2, wherein the ML chatbot is further trained using a plurality of training user inputs corresponding to a plurality of training update templates, and the method further comprises:
receiving, at the one or more processors, a user input corresponding to the update indication; and
generating, by the one or more processors executing the ML chatbot, the update template based upon the user input and in a style representative of the user input.

4. The computer-implemented method of claim 1, wherein the update indication includes (i) a predicted update associated with at least one component of the communication system, (ii) a predicted impact of the predicted update, and (iii) a predicted time of the predicted update.

5. The computer-implemented method of claim 4, further comprising:
receiving, at the one or more processors, a user input including (i) a first indication corresponding to the predicted update associated with the at least one component of the communication system, (ii) a second indication corresponding to an impact of the predicted update to the communication system, and (iii) third indication corresponding to a time of the predicted update; and
re-training, by the one or more processors, the ML chatbot based upon the user input.

6. The computer-implemented method of claim 1, wherein determining that the set of data indicates a potential update further comprises:
generating, by the one or more processors, one or more embeddings associated with the set of data;
comparing, by the one or more processors, the one or more embeddings to a library of embeddings; and
determining, by the one or more processors, that the set of data indicates a potential update based upon the comparing.

7. The computer-implemented method of claim 6, wherein generating the update indication further comprises:
retrieving, by the one or more processors, one or more prior update indications from an update indication database based upon the one or more embeddings; and
generating, by the one or more processors executing the ML chatbot, the update indication based upon the set of data and the one or more prior update indications.

8. The computer-implemented method of claim 1, wherein generating the update indication further comprises:
inputting, by the one or more processors, a plurality of documentation corresponding to the communication system into the ML chatbot; and
generating, by the one or more processors executing the ML chatbot, the update indication based upon the set of data corresponding to the communication system and the plurality of documentation.

9. The computer-implemented method of claim 1, wherein the potential update to the at least one component of the communication system corresponds to at least one of: (i) a software update or (ii) a hardware update.

10. The computer-implemented method of claim 1, wherein:
the one or more sources external to the communication system comprises one or more of: (i) a social media platform, (ii) a news platform, (iii) a blog, (iv) a manufacturer website, or (v) a service provider website; and
the set of data corresponding to the communication system comprises one or more of: (i) a social media post, (ii) an article posted on a news platform, (iii) a blog excerpt, or (iv) a portion of the manufacturer website or the service provider website.

11. A system for proactively managing updates in a communication system, comprising:
a user interface;
one or more processors; and
a non-transitory computer-readable memory coupled to the one or more processors and the user interface, the memory storing instructions thereon that, when executed by the one or more processors, cause the one or more processors to:
retrieve a set of data corresponding to the communication system from one or more sources external to the communication system,
determine, by executing a machine learning (ML) chatbot, that the set of data indicates a potential update to at least one component of the communication system, wherein the ML chatbot is trained with a plurality of training data corresponding to the communication system as inputs to generate a plurality of training update indications as outputs,
generate, by executing the ML chatbot, an update indication corresponding to the set of data, and
display the update indication on the user interface for viewing by a user.

12. The system of claim 11, wherein the instructions, when executed, further cause the one or more processors to generate the update indication by:
generating, by executing the ML chatbot, the update indication corresponding to the set of data and an update template associated with the update indication, and
wherein the update template includes data from the set of data required to process the update for the communication system.

13. The system of claim 12, wherein the ML chatbot is further trained using a plurality of training user inputs corresponding to a plurality of training update templates, and the instructions, when executed, further cause the one or more processors to:
receive a user input corresponding to the update indication; and
generate, by executing the ML chatbot, the update template based upon the user input and in a style representative of the user input.

14. The system of claim 11, wherein the update indication includes (i) a predicted update associated with at least one component of the communication system, (ii) a predicted impact of the predicted update, and (iii) a predicted time of the predicted update.

15. The system of claim 14, wherein the instructions, when executed, further cause the one or more processors to:
receive a user input including (i) a first indication corresponding to the predicted update associated with the at least one component of the communication system, (ii) a second indication corresponding to an impact of the predicted update to the communication system, and (iii) third indication corresponding to a time of the predicted update; and
re-train the ML chatbot based upon the user input.

16. The system of claim 11, wherein the instructions, when executed, further cause the one or more processors to determine that the set of data indicates a potential update by:
generating one or more embeddings associated with the set of data;
comparing the one or more embeddings to a library of embeddings; and
determining that the set of data indicates a potential update based upon the comparing.

17. The system of claim 16, wherein the instructions, when executed, further cause the one or more processors to generate the update indication by:
retrieving one or more prior update indications from an update indication database based upon the one or more embeddings; and
generating, by executing the ML chatbot, the update indication based upon the set of data and the one or more prior update indications.

18. The system of claim 11, wherein the instructions, when executed, further cause the one or more processors to generate the update indication by:
inputting a plurality of documentation corresponding to the communication system into the ML chatbot; and
generating, by executing the ML chatbot, the update indication based upon the set of data corresponding to the communication system and the plurality of documentation.

19. The system of claim 11, wherein:
the one or more sources external to the communication system comprises one or more of: (i) a social media platform, (ii) a news platform, (iii) a blog, (iv) a manufacturer website, or (v) a service provider website; and
the set of data corresponding to the communication system comprises one or more of: (i) a social media post, (ii) an article posted on a news platform, (iii) a blog excerpt, or (iv) a portion of the manufacturer website or the service provider website.

20. A tangible machine-readable medium comprising instructions for proactively managing updates in a communication system that, when executed, cause a machine to at least:
retrieve a set of data corresponding to the communication system from one or more sources external to the communication system;
determine, by executing a machine learning (ML) chatbot, that the set of data indicates a potential update to at least one component of the communication system, wherein the ML chatbot is trained with a plurality of training data corresponding to the communication system as inputs to generate a plurality of training update indications as outputs;
generate, by executing the ML chatbot, an update indication corresponding to the set of data; and
display the update indication on the user interface for viewing by a user.
